(19) United States
(12) Patent Application Publication
(10) Pub. No.: US 2015/0348332 A1
(43) Pub. Date: Dec. 3, 2015

(54) METHOD AND APPARATUS FOR TAXI CAB FARE COLLECTION

(71) Applicant: Hussan Kazmi, Vineland, NJ (US)

(72) Inventor: Hussan Kazmi, Vineland, NJ (US)

(21) Appl. No.: 14/288,758

(22) Filed: May 28, 2014

(51) Int. Cl. G07B 15/00; G06Q 20/20; H04W 4/04; G06Q 20/32

(52) U.S. Cl. CPC G07B 15/00; G06Q 20/3272; G06Q 20/209; H04W 4/046

(57) ABSTRACT

An apparatus allowing someone to safely accept cash and to give change in cash when providing transportation services to the public. The apparatus may include a computer processor, a device for receiving cash and for determining how much cash has been received, and a device for providing a signal to indicate that sufficient cash has been received to pay for transportation services. The computer processor may receive data from the device for receiving cash and for determining how much cash has been received, and the computer processor may cause the device for providing a signal to provide a signal if sufficient cash has been received to pay for transportation services. The apparatus may further include a housing; and the computer processor, the device for receiving cash, and the device for providing a signal may be fixed to the housing.

### FIELD OF THE INVENTION

This invention relates to improved methods and apparatus concerning taxi cabs and collection of fares of fees for taxi cab transportation.

### BACKGROUND OF THE INVENTION

There are various devices known in the prior art for collection of taxi cab fares.

### SUMMARY OF THE INVENTION

One or more embodiments of the present invention allow someone to safely accept cash and to give change in cash when providing transportation services to the public. This is particularly useful to taxi cab drivers who may often provide transportation services at night and in dangerous neighborhoods. Many cab drivers are injured or even die as a result of cash robberies, and one or more embodiments of the present invention may help to prevent these robberies and resulting cab driver casualties.

One or more embodiments of the present invention may also provide a receipt when a cab fare is paid for. In addition a printout of total sales done by a cab driver in a day or in a shift may be printed out or downloaded from a computer memory.

In at least one embodiment, an apparatus is provided comprising a computer processor, a device for receiving cash and for determining how much cash has been received, and a device for providing a signal to indicate that sufficient cash has been received to pay for transportation services. The computer processor may receive data from the device for receiving cash and for determining how much cash has been received, and the computer processor may cause the device for providing a signal to provide a signal if sufficient cash has been received to pay for transportation services. The apparatus may further include a housing; and the computer processor, the device for receiving cash and for determining how much cash has been received, and the device for providing a signal to indicate that sufficient cash has been received to pay for transportation services may be fixed to the housing.

The device for providing a signal may provide a signal in the form of an audio signal or a visual signal if sufficient cash been received to pay for transportation services. The apparatus may further include a device for dispensing change, wherein the computer processor receives data from the device for receiving cash and for determining how much cash has been received, and the computer processor causes the device for dispensing change to dispense change in the amount of the difference between the cash received by the device for receiving cash and the amount due for transportation services.

The apparatus may further include a tracking device attached to the housing, which allows a location of the housing to be tracked by a global positioning system. The apparatus may further include a transportation vehicle to which the housing is attached. The apparatus may further include a computer memory and a computer interactive device, wherein the computer memory has stored therein an audio message, which is played when a user enters a first command via the computer interactive device, and wherein the audio message specifies that the housing has a tracking device attached to it.

The apparatus may be further comprised of a printer, wherein the printer prints a receipt if sufficient cash has been received to pay for transportation services. The transportation vehicle may be an automobile and housing may be attached to the transportation vehicle between a front driver's seat and a front passenger's seat.

In at least one embodiment of the present invention, a method is provided which may include inserting an apparatus into a transportation vehicle which provides transportation services for a fee; and wherein the apparatus may be configured in one or more of the forms specified previously. The transportation vehicle may be an automobile and the apparatus may include a housing which is attached to the transportation vehicle between a front driver's seat and a front passenger's seat or between left and right rear seats.

### BRIEF DESCRIPTION OF THE DRAWINGS

FIG. 1 shows a block diagram of a plurality of components of an apparatus, the apparatus shown in FIG. 2, in accordance with an embodiment of the present invention;

FIG. 2 shows a simplified diagram of the apparatus, located on the inside of a vehicle;

FIG. 3 shows a simplified diagram of another apparatus, similar or identical to the apparatus of FIG. 2, located on the inside of another vehicle; and

FIG. 4 shows a block diagram of a method in accordance with another embodiment of the present invention.

### DETAILED DESCRIPTION OF THE DRAWINGS

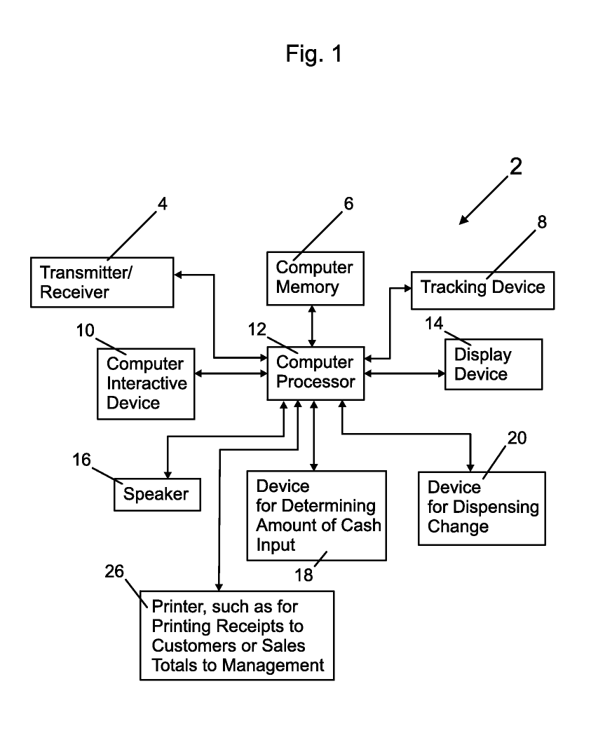

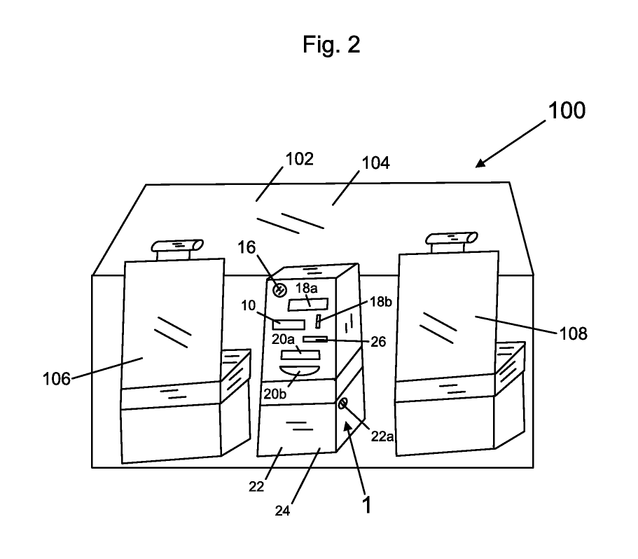

FIG. 1 shows a block diagram of a plurality of components 2 of an apparatus 1, shown in FIG. 2, in accordance with an embodiment of the present invention. The block diagram in FIG. 1 shows a transmitter/receiver 4, a computer memory 6, a tracking device 8, a computer interactive device 10, a computer processor 12, a display device 14, a speaker or audio device 16, a device for determining amount of cash input 18, a device for dispensing change 20, and a printer 26, such as for printing receipts to customers and/or sales totals to management of a cab company that a taxi driver drives for.

The computer processor 12 may be electrically connected to and/or linked by communications links to the transmitter/receiver 4, the computer memory 6, the tracking device 8, the computer interactive device 10, the display device 14, the speaker or audio device 16, the device for determining amount of cash input 18, and the device for dispensing change 20.

The apparatus 1 shown in FIG. 2, may include all of the plurality of components 2 shown in FIG. 1, a safe 20 shown in FIG. 2, and an overall housing 22. All of the components 2 of FIG. 1 may be attached and/or fixed to the overall housing 22 or located in the overall housing 22.

FIG. 2 shows a simplified diagram 100 of the apparatus 1 located on the inside 102 of a vehicle. FIG. 2 shows a windshield 104 from the inside 102 of the vehicle, and a front driver's seat 106, and a front passenger's seat 108 of the vehicle. The vehicle may be an automobile, such as a taxi cab. The apparatus 1 is located between the front driver's seat 106 and the front passenger's seat 108 of the vehicle. In addition to the components 2 shown in FIG. 1, the apparatus 1, as shown in FIG. 2, includes a slot 18a for insertion of paper currency, such as dollar bills, a slot 18b for insertion of coins such as nickels, quarters, and dimes, a dispenser 20a for dispensing change in the form of paper currency, a dispenser 20b for dispensing change in the form of coins, a safe 22, a key slot 22a, and an overall housing 24 are shown.

The apparatus 1 may alternatively be installed attached to the windshield 104.

FIG. 2 shows an outer part of the computer interactive device 10, which can be accessed by a driver to activate the apparatus 1 to start an audio message which may be emitted from the speaker 16. The computer interactive device 10 may include a computer keyboard, computer touchscreen, or other device which allows the driver to input information into the apparatus 1.

The components 2 in FIG. 1 and all of the components of the apparatus 1 in FIG. 2, may be attached and/or fixed to the overall housing 24, and/or may be inserted in or located in the overall housing 24. The apparatus 1 may be fixed and/or mounted to the inside 102 of the vehicle, so that it can not be removed from the vehicle without unbolting or unscrewing it. The apparatus 1 may be fixed in any manner which may, in one or more embodiments be determined by the manufacturer of the vehicle.

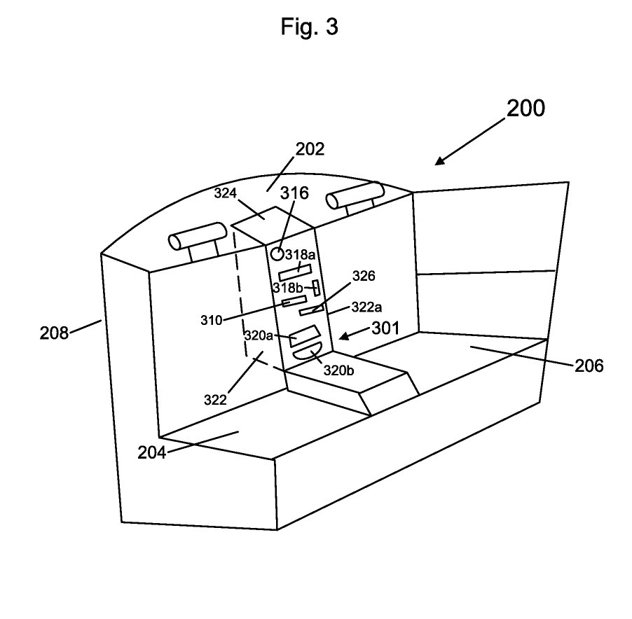

FIG. 3 shows a simplified diagram 200 of part of another apparatus 301, similar or identical to the apparatus 1 shown in FIG. 2, located on the inside 202 of another vehicle. The apparatus 301 may include components identical or analogous to the components 2 shown in FIG. 1. In addition to components, which may be identical to the components 2 shown in FIG. 1, the apparatus 301, as shown in FIG. 3, includes a slot 318a for insertion of paper currency, such as dollar bills, a slot 318b for insertion of coins such as nickels, quarters, and dimes, a dispenser 320a for dispensing change in the form of paper currency, a dispenser 320b for dispensing change in the form of coins, a safe 322, a key slot 322a, and an overall housing 324 are shown. The apparatus 301 may also include a printer 326 which may be identical to the printer 26 of FIG. 1, and which may be used to print receipts to customers and/or print sales totals for a cab company. The computer processor 12 may automatically print receipts to customers via printer 26 and/or 326 after the processor 12 confirms that the amount paid by the customer is greater than the amount of the cab fare, in accordance with a computer program stored in the computer memory 6.

In FIG. 3, the safe 322 is a box shown partially by dashed lines, and protrudes into a trunk of the vehicle which is partially shown in FIG. 3. The apparatus 301 is between a first rear seat 204 and a second rear seat 206 of the vehicle which is partially shown in FIG. 3. The safe 322 protrudes into a trunk 208 of the vehicle which is partially shown in FIG. 3.

FIG. 3 shows an outer part of a computer interactive device 310, which may be identical to computer interactive device 10 shown in FIG. 1, and which can be accessed by a driver to activate the apparatus 301 to start an audio message which may be emitted from a speaker 316, which may be identical to speaker 16. The computer interactive device 310 may include a computer keyboard, computer touchscreen, or other device which allows the driver to input information into the apparatus 301.

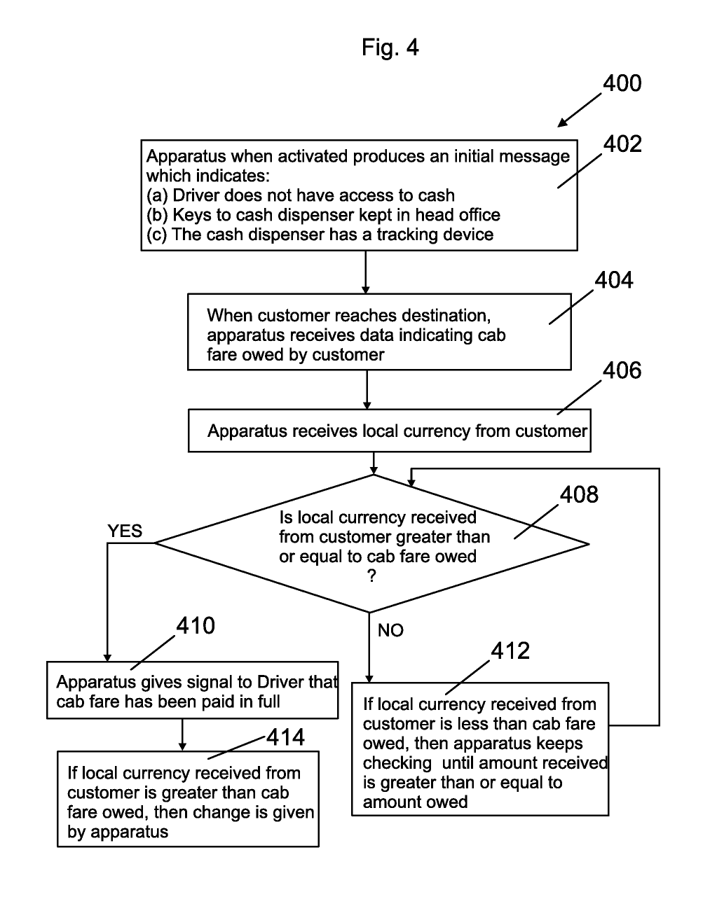

FIG. 4 shows a block diagram 400 of a method in accordance with another embodiment of the present invention for use with the apparatus 1 of FIG. 2, or the apparatus 301 of FIG. 3. At step 402 the apparatus 1 or 301, when activated, such as for example through computer interactive device 10 or 310, may produce an initial audio message, by use of computer processor 12, which may retrieve a message stored as data in computer memory 6 and then output the initial audio message via speaker 16 or 316. The initial audio message may indicate that (a) the driver of the taxi cab does not have access to cash, (b) the key or keys to the “cash dispenser”, i.e the keys or key to opening the safe 22 through key hole or slot 22a or safe 322 through key hole or slot 322a, are kept protected in the main office building of the taxi company, and (c) the apparatus 1 or 301 has a tracking device, such as tracking device 8 of FIG. 1. The computer processor 12 may activate the tracking device 8 of the apparatus 1 or 301 or the tracking device 8 may be always active, and may send out a global positioning satellite (GPS) signal for tracking of the apparatus 1 or 301, which the apparatus 1 or 301 is improperly removed from the inside 102 or 202 of the vehicles.

The initial message provided at step 402 may be announced or emitted from the speaker 16 or 316 a plurality of times as programmed by the computer memory 6 and implemented by the computer processor 12 of FIG. 1. The initial message helps to inhibit and/or prevent a person from hurting and/or robbing a taxi cab driver.

At step 404, when a customer reaches a destination, the apparatus 1 or 301 receives data indicating that cab fare is owed by a customer. For example, the driver may enter cab fare owed into the computer interactive device 10 or 310, or the computer processor 12 may calculate the cab fare owed based on information stored in the computer memory 6, and/or based on a time clock of the computer processor 12, which may be started by the cab driver through computer interactive device 10 or 310 when the ride started.

At step 406, the customer may insert local currency, such as dollar bills, into slot 18a or 318a of the apparatus 1 or 301, respectively At step 408, the computer processor 12 may determine if the local currency inserted into the slot 18a or 318a and received by the device 18 shown in FIG. 1, is greater than or equal to the cab fare owed. If the local currency received is not greater than or equal to the cab fare owed, then at step 412, the apparatus keeps checking by going back to step 408 until an amount of local currency is received which is greater than or equal to the amount owed.

If the local currency received is greater or equal to the amount owed, then at step 410, the computer processor 12 causes a signal to be given to the driver that the cab fare has been paid in full. For example, the computer processor 12 may cause a sound to be emitted by the speaker 16 that the amount has been paid in full, or may cause a visual signal or image to be displayed on the display device 14 that the amount has been paid in full. The computer processor 12 may be programmed by a computer program stored in the computer memory 6 to execute its functions, including the function of providing a signal to indicate paid in full. The amounts paid and the fact that a fare has been paid in full may be stored in the computer memory 6 by the computer processor 12.

The computer processor 12 of the apparatus 1 or 301 may automatically print receipts to customers via printer 26 and/or 326 after the processor 12 confirms that the amount paid by the customer is greater than the amount of the cab fare, in accordance with a computer program stored in the computer memory 6.

At step 414, the amount of local currency paid is greater that the cab fare that the computer processor 12 will cause appropriate change to be given by the device for dispensing change 20 via one or both of the dispensing slots 20a-b and 320a-b shown in FIG. 2 and FIG. 3.

The apparatus 1 or 301 can be used in any transportation vehicle which accepts cash. The apparatus 1 or 301 can be inserted and/or mounted in the rear of a vehicle, between rear seats in an automobile, or between a passenger's and driver's seat of a vehicle. The apparatus 1 or 301 may be adjustable, which may be determined by a manufacturer of the vehicle. The safe 22 in the example of FIG. 2, may be located inside of a glove box of an automobile. The safe 322 in the example of FIG. 3 may be located inside of a rear trunk behind the rear seats of an automobile.

The tracking device 8 may be any known tracking device and may help police or other law enforcement to locate the apparatus 1 or 301 when it is stolen.

The apparatus 1 or 301 may dispense paper receipts to customers. The apparatus 1 or 301 may dispense running total sales printouts per shift or per day to present to management of a taxi cab company that the cab driver works for.

The computer processor 12 may be programmed by a computer program stored in the computer memory 6 to printout sales data for a day or for a shift for a taxi driver via the printer 26 or 326, and in response to one or more inputs through computer interactive device 10. All sales data may be stored in the computer memory 6 and may be accessible by day, by shift, and/or by particular cab driver, for a plurality of days, shifts, and cab drivers.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a computer processor;
a device for receiving cash and for determining how much cash has been received; and
a device for providing a signal to indicate that sufficient cash has been received to pay for transportation services;
and wherein the computer processor receives data from the device for receiving cash and for determining how much cash has been received, and the computer processor causes the device for providing a signal to provide a signal if sufficient cash has been received to pay for transportation services.

2. The apparatus of claim 1 further comprising
a housing; and
wherein the computer processor, the device for receiving cash and for determining how much cash has been received, and the device for providing a signal to indicate that sufficient cash has been received to pay for transportation services are fixed to the housing.

3. The apparatus of claim 1 wherein
the device for providing a signal provides a signal in the form of an audio signal if sufficient cash been received to pay for transportation services.

4. The apparatus of claim 1 wherein
the device for providing a signal provides a signal in the form of a visual signal if sufficient cash been received to pay for transportation services.

5. The apparatus of claim 1 further comprising
a device for dispensing change;
and wherein computer processor receives data from the device for receiving cash and for determining how much cash has been received, and the computer processor causes the device for dispensing change to dispense change in the amount of the difference between the cash received by the device for receiving cash and the amount due for transportation services.

6. The apparatus of claim 2 further comprising
a tracking device attached to the housing, which allows a location of the housing to be tracked by a global positioning system.

7. The apparatus of claim 2 further comprising
a transportation vehicle to which the housing is attached.

8. The apparatus of claim 6 further comprising
a computer memory; and
a computer interactive device; and
wherein the computer memory has stored therein an audio message, which is played when a user enters a first command via the computer interactive device; and
wherein the audio message specifies that the housing has a tracking device attached to it.

9. The apparatus of claim 1 further comprising
a printer; and
wherein the printer prints a receipt if sufficient cash has been received to pay for transportation services.

10. The apparatus of claim 7 wherein
the transportation vehicle is an automobile and housing is attached to the transportation vehicle between a front driver's seat and a front passenger's seat.

11. A method comprising
inserting an apparatus into a transportation vehicle which provides transportation services for a fee;
wherein the apparatus includes:
a computer processor;
a device for receiving cash and for determining how much cash has been received; and
a device for providing a signal to indicate that sufficient cash has been received to pay for transportation services;
and wherein the computer processor receives data from the device for receiving cash and for determining how much cash has been received, and the computer processor causes the device for providing a signal to provide a signal if sufficient cash has been received to pay for transportation services.

12. The method of claim 11 wherein
the apparatus includes a housing; and
wherein the computer processor, the device for receiving cash and for determining how much cash has been received, and the device for providing a signal to indicate that sufficient cash has been received to pay for transportation services are fixed to the housing.

13. The method of claim 11 wherein
the device for providing a signal provides a signal in the form of an audio signal if sufficient cash been received to pay for transportation services.

14. The method of claim 11 wherein
the device for providing a signal provides a signal in the form of a visual signal if sufficient cash been received to pay for transportation services.

15. The method of claim 11 wherein
the apparatus includes a device for dispensing change;
and wherein computer processor receives data from the device for receiving cash and for determining how much cash has been received, and the computer processor causes the device for dispensing change to dispense change in the amount of the difference between the cash received by the device for receiving cash and the amount due for transportation services.

16. The method of claim 12 wherein
the apparatus includes a tracking device attached to the housing, which allows a location of the housing to be tracked by a global positioning system.

17. The method of claim 12 wherein
the apparatus includes a transportation vehicle to which the housing is attached.

18. The method of claim 16 wherein
the apparatus includes a computer memory; and
a computer interactive device; and
wherein the computer memory has stored therein an audio message, which is played when a user enters a first command via the computer interactive device; and
wherein the audio message specifies that the housing has a tracking device attached to it.

19. The method of claim 1 wherein
the apparatus includes
a printer; and
wherein the printer prints a receipt if sufficient cash has been received to pay for transportation services.

20. The method of claim 17 wherein
the transportation vehicle is an automobile and housing is attached to the transportation vehicle between a front driver's seat and a front passenger's seat.
